(19) United States
(12) Patent Application Publication
(10) Pub. No.: US 2003/0140550 A1
(43) Pub. Date: Jul. 31, 2003

(54) Flying insect repellant system utilizing forced air in an exterior area

(76) Inventor: Jay F. Seniff, New Carlisle, IN (US)

Correspondence Address: TAYLOR & AUST, P.C., 142 S. Main St., P.O. Box 560, Avilla, IN, 46710, US

(21) Appl. No.: 10/346,393

(22) Filed: Jan. 17, 2003

Related U.S. Application Data
(63) Continuation-in-part of application No. 09/826,615, filed on Apr. 5, 2001, now abandoned.

(51) Int. Cl. A01M 5/08

(52) U.S. Cl. 43/141

(57) ABSTRACT

A flying insect repellant system includes a duct system, a blower, and a plurality of delivery mechanisms. The duct system has an intake end and a least one exhaust end for the delivery of air. The blower is connected to the intake end of the duct system. A plurality of delivery mechanisms, conjunctively defining a perimeter, each delivery mechanism having at least one orifice being connected to one of said exhaust ends, each said delivery mechanism having an airflow emanating therefrom traveling greater than approximately 1½ miles per hour.

### CROSS REFERENCE TO RELATED APPLICATIONS

This is a continuation-in-part of U.S. patent application Ser. No. 09/826,615, “FLYING INSECT REPELLANT SYSTEM UTILIZING FORCED AIR IN AN EXTERIOR AREA”, Filed Apr. 5, 2001.

### BACKGROUND OF THE INVENTION

1. Field of the invention.

The present invention relates to insect repellant systems, and, more particularly, to a compressed air curtain insect repellent systems.

2. Description of the related art.

The enjoyment which people seek in the out of doors is often diminished when flying insects encroach in the same area. Various methods have been used to reduce the presence of insects in exterior areas. Some rely on the attraction of insects to a device that will kill or trap them. Many utilize chemical repellents which are applied to the exposed skin, dispersed in the air by burning or mechanical means, or applied to the ground in an area desired to be free of insects. Chemical applications are also used to simply kill insects in an area.

When it is desirable to exclude flying insects in the area of a doorway or a window of a building, particularly if the doorway or window is in the vicinity of light or odors which attract flying insects, the use of a device that provides an airflow across the opening may be used to discourage flying insects from entering an open door or window or alighting on the door or window. Such a system thus has been used in conjunction with openings in buildings which are otherwise impervious to flying insects, offering protection to those inside the building or immediately adjacent to the building, but not in open areas.

Insect repellent systems have been integrated into furniture which utilize air nozzles to force air around the occupant. Such furniture is designed to provide air stream barriers around the furniture's occupant, particularly around areas of exposed skin to discourage flying insects from alighting on the occupant. The use of an airflow issuing from a piece of furniture to prevent flying insects from alighting on an individual has the drawback of requiring the person to remain in place on the furniture in order to receive the benefit afforded by the airflow.

What is needed in the art is a device that can be used to exclude flying insects from an exterior area without the use of chemicals, insect traps or the necessity of walls or enclosures.

### SUMMARY OF THE INVENTION

The present invention provides a flying insect repellant system in an exterior area by providing a perimeter boundary of moving air.

The invention comprises, in one form thereof, a device for the exclusion of flying insects from an exterior area which includes a duct system, a blower and a plurality of delivery mechanisms. The duct system has an intake end and a least one exhaust end for the delivery of air. The blower is connected to the intake end of the duct system. A plurality of delivery mechanisms, conjunctively defining a perimeter, each delivery mechanism having at least one orifice being connected to one of said exhaust ends, each said delivery mechanism having an airflow emanating therefrom traveling greater than approximately 1½ miles per hour.

An advantage of the present invention is that it will assist in causing an exterior area to be free of flying insects.

Another advantage is that the insect free area is created without the use of chemicals or the trapping and killing of insects.

Yet another advantage is that the moving air will serve to keep the air in an area fresher and more pleasant to the occupants.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic, perspective illustration of a flying insect repellant system according to an embodiment of the invention;

FIG. 2 is a schematic, perspective illustration of a set of risers and railings of another embodiment of the flying insect repellent system of the present invention;

FIG. 3 is a front view of an embodiment of a riser configured for the top discharge of air;

FIG. 4 is a side view of an embodiment of a riser configured for the angular discharge of air;

FIG. 5 is a perspective illustration of another embodiment of a flying insect repellent system of the present invention;

FIG. 6 is an exploded perspective view of the flying insect repellent system of FIG. 5;

FIG. 7 is a side view of a railing section of the flying insect repellent system of FIGS. 5 and 6;

FIG. 8 is a top view of the railing section of FIG. 7;

FIG. 9 is a perspective view of an air nozzle assembly of the insect repellent system of FIGS. 5-8; and

FIG. 10 is an exploded perspective view of the air nozzle assembly of FIG. 9.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

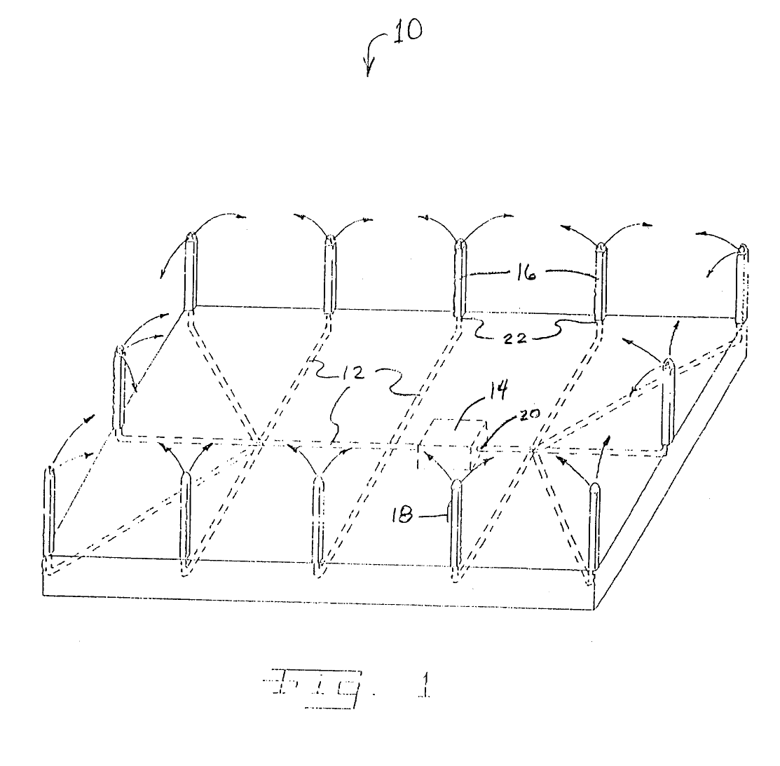

Referring now to the drawings, and more particularly to FIG. 1, there is shown a flying insect repellant system 10 including a duct system 12, a blower 14, a plurality of delivery mechanisms 16 and a control system 18.

Duct system 12 is configured with an intake end 20 and a plurality of exhaust ends 22, to deliver airflow from blower 14 to each delivery mechanism 16. In one embodiment of the invention, duct system 12 would be installed under a porch, deck, patio or yard (not labeled) with exhaust ends 22 being configured to connect to delivery mechanisms 16, shown as risers. Intake end 20 can be located in the area desired to be free of flying insects, such as under a deck, or it can be located in such a manner as to bring fresh air into the area and/or to lessen the potential distraction which any noise that may be generated by blower 14 may create.

Blower 14 forces air into intake end 20 of duct system 12. In one embodiment of the invention, blower 14 may be a squirrel cage blower attached to an electric motor.

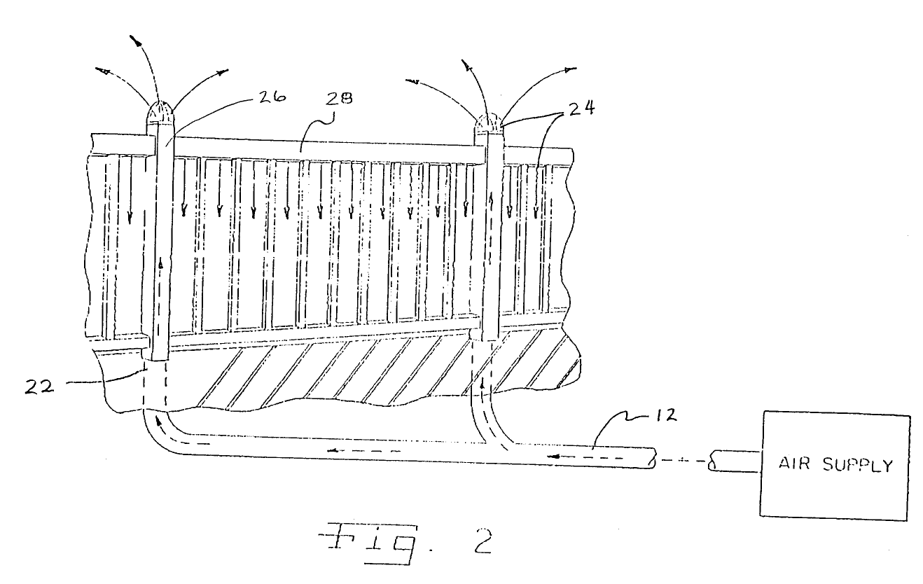

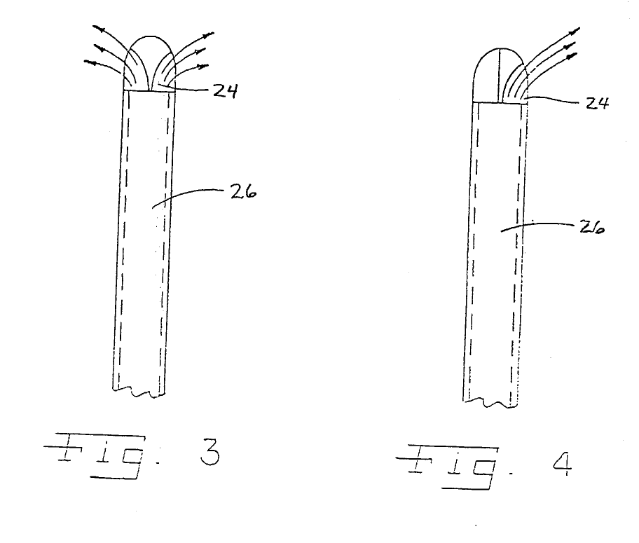

Delivery mechanisms 16 are configured with internal air passageways and are connected to exhaust ends 22 of duct system 12 for the delivery of the airflow to orifices 24 which are a part of each delivery mechanism 16. Orifices 24 are so directed as to provide a flow of air into the surrounding atmosphere to create an airflow boundary to inhibit the intrusion of flying insects. In one embodiment of the invention, delivery mechanisms 16 may be some combination of risers 26 and/or railings 28, such as shown in FIG. 2, where risers 26 and railings 28 are configured with orifices 24 for the discharge of air creating an airflow boundary. The orientation of some orifices 24 will include, but not be limited to, top discharge as shown in the riser of FIG. 3, and the discharge, of air oriented to provide an overhead airflow boundary, as illustrated in FIG. 4.

Integrating the delivery mechanisms 16 into structures, such as risers 26 and railings 28, that routinely appear around decks, porches, patios and yards, provides for a system that is unobtrusive to the aesthetics of an outdoor space. By the manner of a particular installation, the airflow boundary may be directed in a combination of directions to form the desired boundary for the exclusion of flying insects.

Control system 18 is connected to blower 14 for the purpose of varying the airflow which blower 14 delivers to duct system 12. In one embodiment of the invention, control system 18 is an electronic control of an electric motor which powers a fan of blower 14 at a desired operating speed.

During operation, and referring to FIG. 1, duct system 12 directs an airflow provided by blower 14 at intake end 20 of duct system 12 to a plurality of exhaust ends 22 of duct system 12. Delivery mechanisms 16 receive airflow from each exhaust end 22 and disburse the air through orifices 24 causing the creation of an airflow boundary for the exclusion of flying insects. Control system 18 allows control over the speed of blower 14, thus controlling the velocity of the air in the system and the intensity of the airflow boundary.

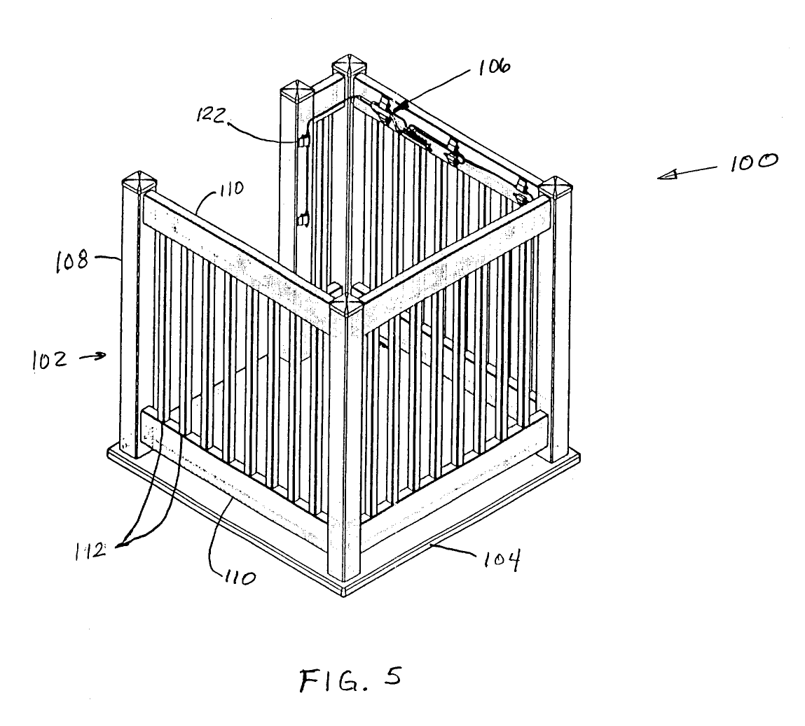

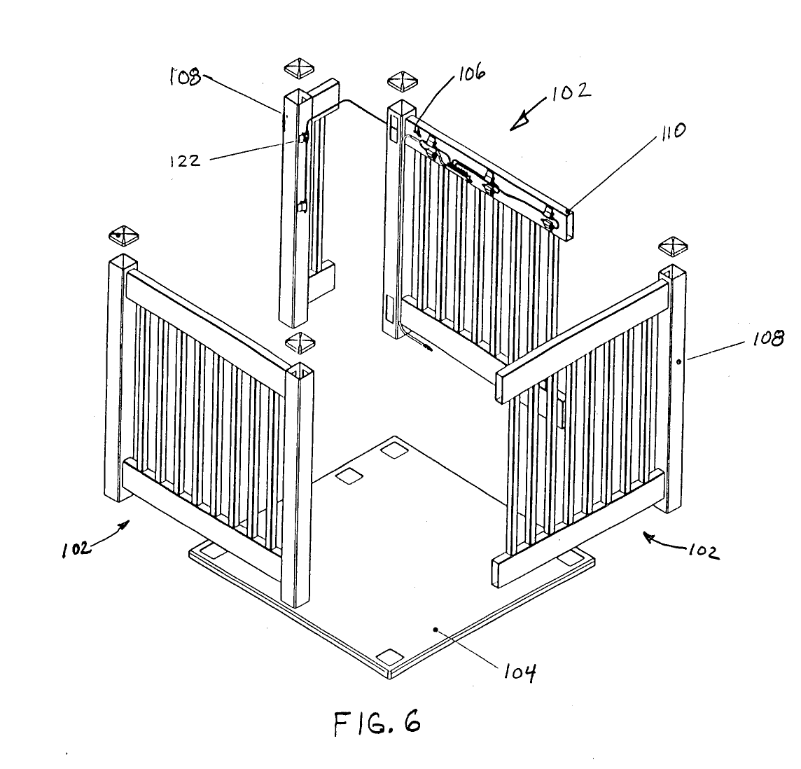

Now additionally referring to FIGS. 5 and 6 there is shown another embodiment of the present invention including insect repellent system assembly 100 having several boundary defining elements in the form of railing sections 102, floor 104 and insect repellent system 106.

Railing section 102 includes posts 108, rails 110 and banisters 112. Posts 108 are attached to at least one end of each railing section 102, thereby providing vertical support and interaction with floor 104. Two rails 110 extend horizontally from each post 108 providing support for banisters 112, which are vertically orientated between rails 110. Each railing section 102 has integrated either on, internal to or partially internal to rails 110 and post 108 an insect repellent system 106. Each railing section 102 interfaces mechanically with another railing section 102 and with a compressed air source, not shown.

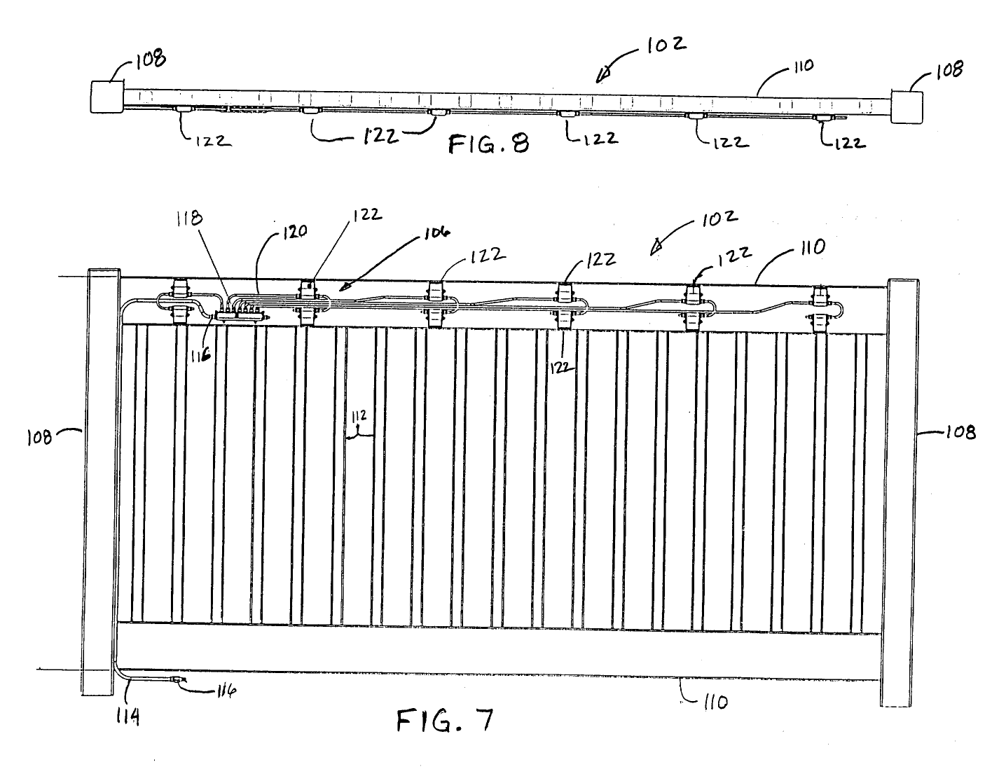

Now, additionally referring to FIGS. 7 and 8 there is illustrated insect repellent system 106 including compressed air hose 114, compressed air connector 116, manifold 118, compressed air interconnections 120 and nozzle assemblies 122. Compressed air hose 114 by way of a compressed air connector 116 is interconnected to a compressed air source, not shown. The compressed air source provides compressed air to insect repellent system 106, the pressure of the compressed air source being regulated as required to provide an airflow out of nozzle assemblies 122. Additional manifolds 118 may be positioned and included in assembly 100 to interconnect compressed air hoses 114 from each railing section 102 to thereby provide compressed air to each portion of insect repellent system 106 attached to each railing system 102.

Manifold 118 includes a number of receptacles to accommodate compressed air connectors 116 from compressed air hoses 114 and compressed air interconnections 120. Manifold 118 provides pressurized air to each of the compressed air interconnections 120. Manifold 118 is attached to a surface of railing 110 or is enclosed therein.

Compressed air interconnections 120 provide compressed air from manifold 118 to nozzle assemblies 122. Compressed air interconnections 120 may be made of plastic airline hose with a connector attached to each end thereof. Compressed air interconnections 120 come in a variety of lengths as illustrated in FIG. 7. Some of the compressed air interconnections 120 connect from a nozzle assembly 122 to another nozzle assembly 122 thereby daisy chaining the compressed air system from one nozzle assembly 122 to another nozzle assembly 122.

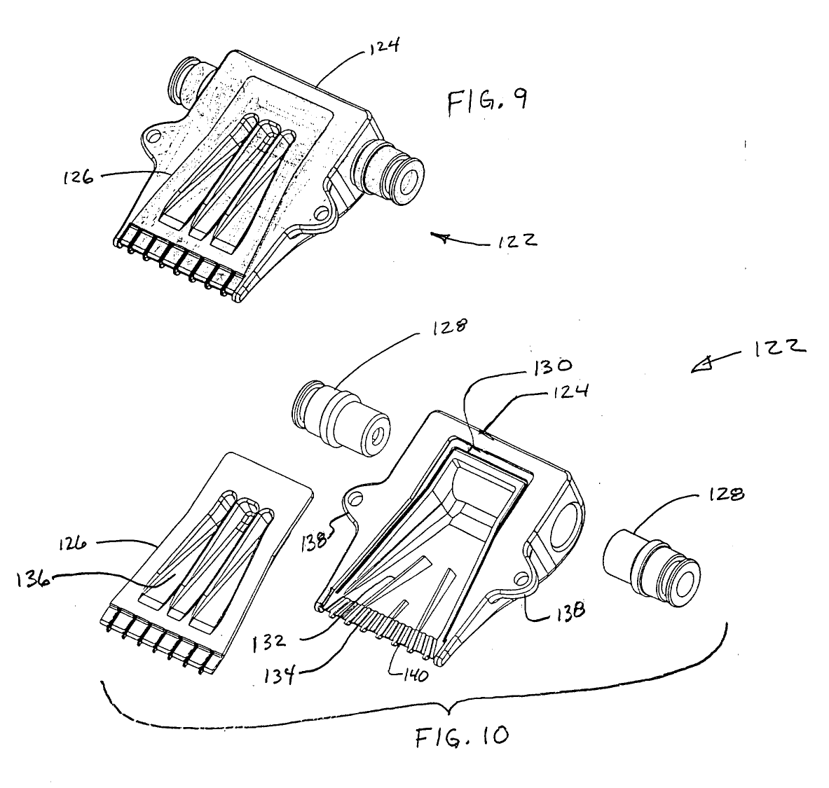

Now, additionally referring to FIGS. 9 and 10 nozzle assemblies 122 are generally oriented to direct compressed air from nozzle assemblies 122 in a vertical direction as shown in FIG. 7. In instances where an opening in railing sections 102 exists, as shown in FIG. 5, nozzle assemblies 122 can be oriented to move air in a substantially horizontal direction, thereby allowing the compressed air curtain to provide protection to ingress and egress openings in insect repellent system assembly 100.

Each nozzle assembly 122 includes a nozzle main body 124, a nozzle restriction insert 126, connectors 128 and bonding adhesive 130. Nozzle restriction insert 126 is connected to nozzle main body 124 by utilizing bonding adhesive 130 that is applied to three edges of nozzle restriction insert 126. Connectors 128 are inserted into nozzle main body 124 and an adhesive may be used to attach connectors 128 to nozzle main body 124. Alternatively, connectors 128 may be molded integrally with nozzle main body 124. Air that goes through connectors 128 is also used to pressurize the internal cavity formed by the bonding of nozzle restriction insert 126 to nozzle main body 124.

Nozzle main body 124 includes main airflow diverters 132 and secondary airflow diverters 134. Nozzle restriction insert 126 includes airflow constrictors 136. Nozzles 140 are formed as air channels between a portion of nozzle restriction insert 126 and a portion of nozzle main body 124. Nozzles 140 are formed at angles which progressively vary to thereby direct air in a fan-like manner from nozzle assembly 122. Airflow constrictors 136 coact with airflow diverters 132 to reduce the amount of airflow, thereby maintaining pressure, and to direct the airflow toward nozzles 140. Nozzle assembly 122 directs air in a fan-shaped planar direction. Alternatively, nozzle restriction insert 126 may take a different form to thereby allow a variation in the amount of airflow and direction of the airflow from nozzle assembly 122.

Nozzle assembly 122 includes mounting tabs 138 having holes therethrough to accommodate mounting hardware for removable attachment to rails 110. Nozzle assemblies 122 may be positioned within rails 110 and the air directed through slots (not shown) in rails 110 thereby concealing the elements of insect repellent system 106.

Research by the inventor has shown that a directed external airflow of approximately 1½ miles per hour issuing from nozzle 140 of nozzle assembly 122 is sufficient to deter most flying insects from invading a boundary defined by insect repellent assembly 100. Experimental testing shows that air velocity of 2 miles per hour or greater is an even greater deterrent to flying insects. The research also concluded that air can be directed from nozzle assemblies 122 located approximately 16 inches apart along railing 110 as shown in FIG. 7. Air is directed from nozzle assemblies 122 in a fan-like manner providing airflow along a substantially vertical plane in a generally upward and downward direction as shown in FIG. 7 or in a horizontal direction, as shown in FIG. 5, to thereby dissuade flying insects from encroaching upon a perimeter defined by insect repellent assembly 100.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A flying insect repellant system, comprising:
a duct system with an intake end and at least one exhaust end for the delivery of air;
a blower connected to said intake end; and
a plurality of delivery mechanisms, conjunctively defining a perimeter, each said delivery mechanism having at least one orifice and being connected to one of said exhaust ends, each said delivery mechanism having an airflow emanating therefrom traveling greater than approximately 1½ miles per hour.

2. The flying insect repellant system of claim 1, further including control system coupled to said blower for the control of the amount of air forced into said duct system.

3. The flying insect repellant system of claim 2, wherein said control system comprises an electrical control.

4. The flying insect repellant system of claim 1, wherein said perimeter defines one of a patio, porch, deck and yard.

5. The flying insect repellant system of claim 1, wherein said delivery mechanisms include risers and railings.

6. The flying insect repellant system of claim 5, wherein said risers and said railings each have at least one internal air passageway and at least one orifice in fluid communication with said at least one internal air passageway.

7. The flying insect repellant system of claim 1, wherein each said orifice is a nozzle.

8. The flying insect repellant system of claim 1, wherein said blower is an electric blower.

9. The flying insect repellant system of claim 1, wherein said duct system is constructed of plastic pipe.

10. The flying insect repellant system of claim 1, wherein said airflow is greater than approximately 2 miles per hour.

11. A method of excluding flying insects from an area using directed airflow, said method comprising the steps of:
providing a blower, duct system, coupled to said blower and a plurality of delivery mechanisms coupled to said duct system and conjunctively defining a perimeter;
generating an airflow in said duct system, with said blower;
distributing the airflow through said duct system and into said plurality of delivery mechanisms; and
directing a portion of said airflow through each said delivery mechanism, thereby creating an external airflow of greater than approximately 1½ miles per hour.

12. The method of excluding flying insects of claim 10, further comprising the step of controlling the velocity of the airflow by controlling the speed of said blower.

13. A modular insect repellant system, comprising:
a plurality of boundary defining elements, each of said plurality of boundary defining elements further comprising:
at least one structural member;
at least one nozzle assembly connected to at least one said structural member, said at least one nozzle assembly having at least one air channel; and
a compressed air supply connected to said at least one air channel such that an airflow issues from said air channel at a velocity of at least approximately 1½ miles per hour.

14. The system of claim 13, wherein said plurality of boundary defining elements includes a first boundary defining element and a second boundary defining element, said first boundary defining element interconnected to said second boundary defining element.

15. The system of claim 13, wherein said at least one nozzle assembly is a plurality of nozzle assemblies, including a first nozzle assembly and a second nozzle assembly, said first nozzle assembly being oriented to direct said airflow in a substantially upward vertical flow, said second nozzle assembly being oriented to direct said airflow in a substantially downward vertical flow.

16. The system of claim 15, wherein each of said plurality of nozzle assemblies produce a fan-shaped airflow.

17. The system of claim 16, wherein said plurality of nozzle assemblies additionally include a third nozzle assembly, said third nozzle assembly oriented to direct said fan-shaped airflow in a generally horizontal direction.
